(19) United States
(12) Patent Application Publication
(10) Pub. No.: US 2020/0349632 A1
(43) Pub. Date: Nov. 5, 2020

(54) Dynamic Hierarchical Delivery System

(71) Applicant: MavenWork, Inc., San Francisco, CA (US)

(72) Inventors: Cong Xu, San Francisco, CA (US); Yi Zheng, Palo Alto, CA (US); Evan Alan Meyer, San Francisco, CA (US)

(73) Assignee: MavenWork, Inc., San Francisco, CA (US)

(21) Appl. No.: 16/403,490

(22) Filed: May 3, 2019

(51) Int. Cl. G06Q 30/06; G06Q 50/12; G06Q 10/06; G06Q 10/08

(52) U.S. Cl. CPC G06Q 30/0635; G06Q 10/087; G06Q 10/06316; G06Q 50/12

(57) ABSTRACT

An electronic device in a system splits an order for multiple prepared beverage products into a subset of the order fulfilled by a mobile store in the system and a second subset of the order fulfilled by a second mobile store in the system, where the mobile store and the second mobile store fulfill orders by fabricating prepared beverage products in a set of prepared beverage products and delivering the prepared beverage products to destination locations. Next, the electronic device provides an instruction intended for the mobile store and a second instruction intended for the second mobile store, where the instruction specifies a destination location and the subset of the order to be fulfilled by the mobile store, and the second instruction specifies the second subset of the order to be fulfilled by the second mobile store and one of: the destination location or an exchange location.

### BACKGROUND

### Field

The described embodiments relate to techniques for fulfilling customer food and/or beverage orders using a dynamic and integrated arrangement of mobile stores.

### Related Art

The increased availability and capabilities of portable electronic devices (such as cellular telephones) and the performance of networks (such as the Internet) continue to dramatically change how people interact with each other, obtain entertainment, order and receive products and, thus, people's lives. For example, in recent years, these technologies have enabled e-commerce companies to offer food delivery services via an online marketplace. Notably, instead of restaurants and other businesses employing dedicated food delivery employees, these e-commerce companies bring together restaurants and the other business, third-party delivery contractors and customers via Web-based technology to provide food delivery. In principle, these food delivery services: allow the restaurants and the other business to reach a broader market at lower costs; allow the third-party delivery contractors to earn additional income and control over their work schedules; and offer customers more choices and delivery flexibility.

In practice, it is usually difficult to achieve these objectives. Notably, it is often difficult to scale a food delivery service. For example, while some additional choice is welcome, most customers are creatures of habit. Over time, they tend to order a small subset of the available options from particular restaurants. Nonetheless, the need to support a large number of restaurants with diverse menus adds complexity and cost. Moreover, too many choices are confusing too customers.

Furthermore, while delivery flexibility seems attractive, because of biological need and cultural convention, most customers typically eat meals (such as dinner) at around the same times (e.g., between 5 and 8 pm). This surge in demand creates a bottleneck in the food delivery process. For example, because most fresh food is perishable and due to customer taste and dietary preferences, most restaurants prepare meals when they are ordered. However, most restaurants have limited staffs and kitchen capacity, which are intended to primarily service their dine-in customers during such a ‘dinner rush,’ which is when restaurants attempt to bring in revenue to cover their overhead and fixed costs. While additional revenue opportunities associated with a larger pool of customers are welcome, most restaurants have limited spare capacity that they can use to fulfill these customers. What this means in practice is either scarcity (a limit to the number of online orders that will be accepted) or extended food-preparation delays.

Similarly, there is a finite pool of third-party delivery contractors and the e-commerce companies are forced to compete for them. This increases the costs for the e-commerce companies. In conjunction with the complexity of supporting a large number of restaurants and customers, this can constrain or even eliminate profits. In addition, the same forces that lead customers to order food for delivery at certain times, also leads to large increases in road traffic. Consequently, it can be difficult for third-party delivery contractors to pick up meals from restaurants and to promptly deliver these orders to customers. This constraint can further limit the revenue opportunities for the restaurants, the third-party delivery contractors and the e-commerce companies, and can further degrade the overall customer experience.

### SUMMARY

A described embodiment relates to a system for fulfilling prepared-beverage orders. This system may include a fulfillment hub, a set of mobile stores and an electronic device. The fulfillment hub may store inventory for a set of prepared beverage products. Moreover, the set of mobile stores may: receive portions of the inventory from the fulfillment hub; move to different locations in assigned geographic operating regions; and fulfill orders, where the fulfilling involves use of the set of mobile stores to fabricate prepared beverage products in the set of prepared beverage products using the portions of the inventory and to deliver the prepared beverage products to destination locations. Furthermore, the electronic device may: receive information specifying an order, where the order is associated with a customer and includes information specifying a destination location and multiple prepared beverage products; split the order into a subset of the order fulfilled by a mobile store in the set of mobile stores and a second subset of the order fulfilled by a second mobile store in the set of mobile stores, where the splitting is based at least in part on: a location of the mobile store, a location of the second mobile store, an unused remainder of a portion of the inventory in the mobile store, an unused remainder of a second portion of the inventory in the second mobile store, a workload of the mobile store, and/or a workload of the second mobile store; and provide an instruction intended for the mobile store and a second instruction intended for the second mobile store, where the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.

In some embodiments, the information specifying the order includes a time or timestamp, and the instructions and/or the second instructions include a delivery time. For example, the delivery time may be within 30 minutes of the time or the timestamp.

Note that the set of prepared beverage products may include coffees and teas.

Moreover, the electronic device may provide information, intended for the fabrication hub or the set of mobile stores, that specifies the portions of the inventory for the set of mobiles stores, where the portions of the inventory are varied at different times of day based at least in part on previous orders received by the system.

Furthermore, the electronic device may predict the order based at least in part on a previous order from the customer for an instance or a prepared beverage product, which was received by the system. Additionally, prior to the electronic device receiving the order, the electronic device may provide information, intended for the fabrication hub or the mobile store, that specifies the portion of the inventory for the mobile store that includes ingredients in the prepared beverage product based at least in part on the prediction.

In some embodiments, the instruction and/or the second instruction may specify exchange of material in portions of the inventory or the second portion of the inventory between the mobile store and the second mobile store. Note that the exchanged material may be based at least in part on: an unused remainder of the portion of the inventory in the mobile store, an unused remainder of the second portion of the inventory in the second mobile store, the subset of the order, the second subset of the order, a location of the mobile store, a location of the second mobile store, an assigned geographic operating region of the mobile store, an assigned geographic operating region of the second mobile store, and/or a predicted future order based at least in part on the previous orders received by the system.

Moreover, the electronic device may provide information, intended for the set of mobile stores, that specifies the assigned geographic operating regions, where the assigned geographic operating regions are varied at different times of day based at least in part on previous orders received by the system.

Furthermore, the portions of the inventory may include pre-prepared portions of prepared beverage products in the set of prepared beverage products. A pre-prepared portion of a prepared beverage product may include a liquid corresponding to the prepared beverage product, and the fulfilling may involve use of the set of mobile stores to fabricate remainders of the prepared beverage products using the pre-prepared portions of the prepared beverage products.

For example, the prepared beverage product may include a type of tea and the pre-prepared portion of the prepared beverage product may be a pre-steeped liquid and may have a tea-extract concentration that exceeds a tea-extract concentration of the prepared beverage product. Alternatively, or additionally, the prepared beverage product may include a type of coffee and the pre-prepared portion of the prepared beverage product may be a pre-brewed liquid and may have a coffee-extract concentration that exceeds a coffee-extract concentration of the prepared beverage product. In some embodiments, the pre-prepared portion of the prepared beverage product may include pre-cooked tapioca pearls or a chemical that reduces perceived bitterness (such as sugar, milk, almond milk, soy milk or cream). Alternatively, or additionally, the pre-prepared portion of the prepared beverage product may include toppings, such as: jelly, pudding, custard, fruit bits and, more generally, small chunks of food that can pass through the diameter of a straw.

Additionally, fabricating the remainders of the prepared beverage products may include adding amounts of liquid to the pre-prepared portions of the prepared beverage products to obtain desired concentrations of the prepared beverage products or adding toppings to the prepared beverage products. Note that the amounts of liquid may have temperatures that are higher than room temperature. In some embodiments, fabricating the remainders of the prepared beverage products may include adding customized art work to containers that convey the prepared beverage products. For example, given customized art work may be selected based at least in part on information about a given customer associated with the previous orders received by the system and/or a selection provided by the given customer.

Note that in some embodiments the system provides prepared foods, packaged goods or other products.

Another embodiment provides a computer-readable storage medium for use with the electronic device. This computer-readable storage medium may include program instructions that, when executed by the electronic device, causes the electronic device to perform at least some of the aforementioned operations.

Another embodiment provides a method. This method includes at least some of the operations performed by the electronic device.

Another embodiment provides a sealed package or cartridge that includes a pre-prepared portion of a prepared beverage product.

Another embodiment provides a mobile store.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example of a method for fulfilling prepared-beverage orders in the system in FIG. 1 in accordance with an embodiment of the present disclosure.

FIG. 3 is a drawing illustrating an example of interactions among the electronic devices in FIG. 1 in accordance with an embodiment of the present disclosure.

FIG. 4 is a drawing of an example of a mobile store in the system in FIG. 1 in accordance with an embodiment of the present disclosure.

FIG. 5 is a drawing illustrating an example of a container for a prepared beverage in accordance with an embodiment of the present disclosure.

FIG. 6 is a block diagram illustrating an example of an electronic device in the system of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A system that fulfills prepared-beverage orders is described. During operation, an electronic device in a system receives information specifying an order, where the order is associated with a customer and includes information specifying a destination location and multiple prepared beverage products. Then, the electronic device splits the order into a subset of the order fulfilled by a mobile store in the system and a second subset of the order fulfilled by a second mobile store in the system, where the mobile store and the second mobile store fulfill orders by fabricating prepared beverage products in a set of prepared beverage products using portions of inventory from a fabrication hub in the system and delivering the prepared beverage products to destination locations. Note that the splitting may be based at least in part on: a location of the mobile store, a location of the second mobile store, an unused remainder of a portion of the inventory in the mobile store, an unused remainder of a second portion of the inventory in the second mobile store, a workload of the mobile store, and/or a workload of the second mobile store. Next, the electronic device provides an instruction intended for the mobile store and a second instruction intended for the second mobile store, where the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.

By splitting the order, this delivery technique may facilitate improved prepared beverage products and, more generally, improved food delivery. Notably, the delivery technique may increase the efficiency of the prepared-beverage fulfillment process, which may reduce the time and costs associated with fulfilling the order. Consequently, the delivery technique may make it easier to scale a prepared-beverage delivery service, and more generally a food delivery service. For example, the delivery technique may help ensure a predictable and a reliable supply of inventory, technology and a workforce, so that it is easier to fulfill dynamic customer demand. Moreover, the delivery technique may offer improved service (such as a faster and more-reliable delivery time) to the customer, which may improve customer satisfaction and loyalty.

In the discussion that follows, electronic devices or components in a system may communicate packets or frames in accordance with a wireless communication protocol, such as: a wireless communication protocol that is compatible with an IEEE 802.11 standard (which is sometimes referred to as ‘Wi-Fi®,’ from the Wi-Fi Alliance of Austin, Tex.), Bluetooth® (from the Bluetooth Special Interest Group of Kirkland, Washington), a LoRa communication protocol (from the LoRa Alliance of Fremont, Calif.) and/or another type of wireless interface (such as another wireless-local-area-network interface). Alternatively, or additionally, electronic devices or components in the system may communicate packets or frames using a wired communication protocol, such as a wired communication protocol that is compatible with an Institute of Electrical and Electronics Engineers (IEEE) 802.3 standard (which is sometimes referred to as ‘Ethernet’), e.g., an Ethernet II standard. However, a wide variety of communication protocols may be used in the electronic devices and/or the system, including wired and/or wireless communication. In the discussion that follows, Ethernet and Wi-Fi are used as illustrative examples.

Moreover, in the discussion that follows, a ‘prepared beverage product’ may be a beverage product that is ordered by a customer and that is, at least in part, prepared or fabricated by or in a mobile store or a mobile retail establishment based at least in in part on the customer's order. Thus, a ‘prepared beverage product’ may, at least in part, be made to order for the customer, as opposed to a canned beverage product (such as bottled coffee) that is prefabricated at a factory. Furthermore, in the discussion that follows a ‘mobile store’ may be a type of vehicle (such as a truck) that, at least in part, fabricates or is used to fabricate prepared beverage products using equipment in the mobile store (such as using a beverage preparation device). Additionally, in the discussion that follows, a ‘mobile hub’ may be a type vehicle (such as a truck) that conveys or brings inventory to the mobile stores and/or that may pre-prepare or that is used to pre-prepare at least a portion of a prepared beverage product for the mobile stores. Alternatively, in the discussion that follows, a ‘fabrication hub’ may be a fixed facility (such as a warehouse and/or a factory) that stores inventory for a mobile hub or a mobile store, and/or that pre-prepares or that is used to pre-prepare at least a portion of a prepared beverage product for the mobile stores.

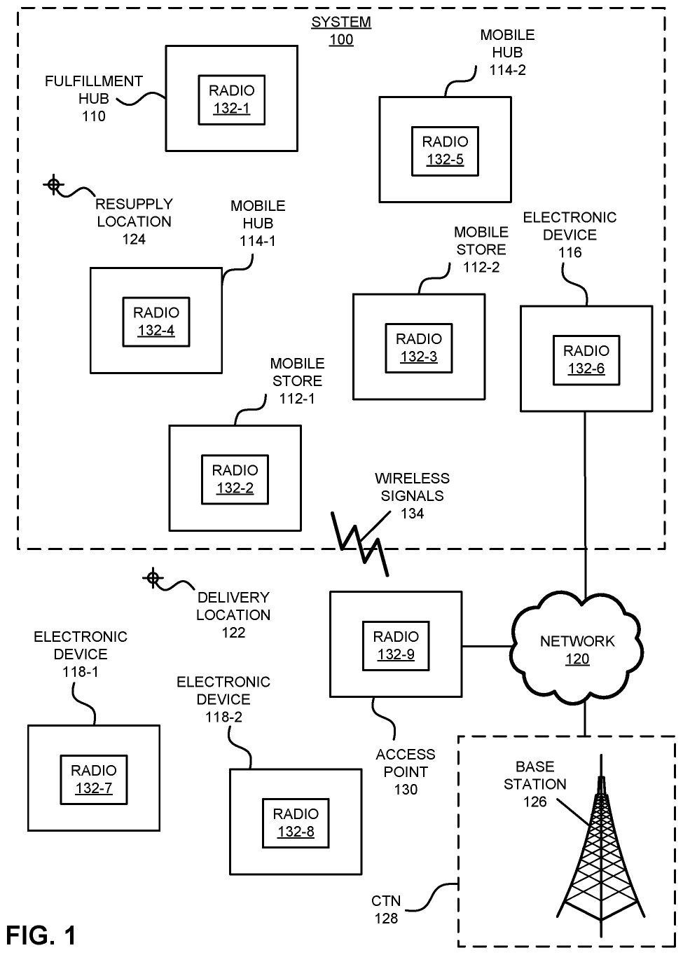

We now describe some embodiments of the delivery technique. FIG. 1 presents a block diagram illustrating an example of a system 100, which may include components, such as: a fulfillment hub 110, mobile stores 112 (which are sometimes referred to as ‘mobile trucks,’ ‘mobile retail establishments,’ or ‘mobile fulfillment platforms’), one or more optional mobile hubs 114, and/or an electronic device 116 (such as a computer or a server). In system 100, electronic device 116 may communicate with one or more other components in system 100 using wired and/or wireless communication. Moreover, electronic device 116 may communicate with one or more electronic devices 118 associated with customers of system 100 (such as cellular telephones, stations, another type of electronic device, etc.) using wired and/or wireless communication. For example, the wireless communication may be compatible with an IEEE 802.11 standard. Thus, the wireless communication may occur in a 2.4 GHz, a 5 GHz and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’) However, a wide variety of frequency bands may be used. Furthermore, the communication may occur via network 120 (such as the Internet, an intra-net and/or one or more dedicated links). Note that some of the components in system 100 may be at a common location, while other components (such as mobile stores 112 and/or the one or more optional mobile hubs 114) may be at other, variable locations (e.g., these components may move to different locations, such as a delivery location 122 or a resupply location 124) as a function of time. While not shown in FIG. 1, there may be additional components or electronic devices, such as a router.

Additionally, as noted previously, one or more components in system 100 and/or one or more of electronic devices 118 may communicate via wireless communication. For example, mobile store 112-1 may wirelessly communicate with a base station 126 in a cellular-telephone network (CTN) 128 and/or with an access point 130 that provides access to network 120 via an Ethernet protocol (such as a physical access point or a virtual or ‘software’ access point that is implemented on a computer or an electronic device). This wireless communication may involve: transmitting advertising frames on wireless channels, detecting one another by scanning wireless channels, exchanging subsequent data/management frames (such as association requests and responses) to establish a connection, configure security options (e.g., Internet Protocol Security), transmit and receive frames or packets via the connection (which may include the association requests and/or additional information as payloads), etc.

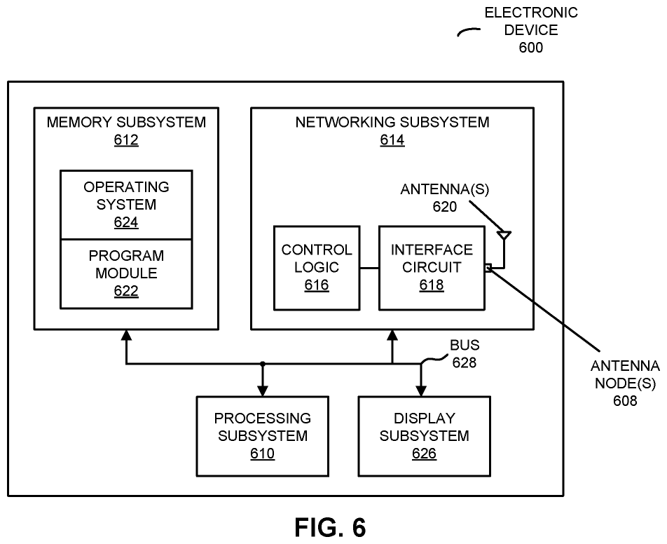

As described further below with reference to FIG. 6, fulfillment hub 110, mobile stores 112, the one or more optional mobile hubs 114, electronic device 116, electronic devices 118, base station 126 and/or access point 130 may include subsystems, such as a networking subsystem, a memory subsystem and a processor subsystem. In addition, fulfillment hub 110, mobile stores 112, one or more optional mobile hubs 114, electronic device 116, electronic devices 118, base station 126 and/or access point 130 may include radios 132 in the networking subsystems. More generally, fulfillment hub 110, mobile stores 112, the one or more optional mobile hubs 114, electronic device 116, electronic devices 118, base station 126 and/or access point 130 can include (or can be included within) any electronic devices with the networking subsystems that enable these components to communicate with each other using wired and/or wireless communication.

As can be seen in FIG. 1, wireless signals 134 (represented by a jagged line) may be transmitted from a radio 132-2 in mobile store 112-1. These wireless signals are received by radio in at least one of base station 126 and/or access point 130 (such as radio 132-9). In particular, radio 132-2 may transmit frames or packets. In turn, these frames or packets may be received by, e.g., access point 130. This may allow mobile store 112-1 to communicate information with electronic device 116. In the described embodiments, processing a frame or a packet by radios 132 may include: receiving wireless signals 134 with the frame or packet; decoding/extracting the frame or packet from the received wireless signals 134 to acquire the frame or packet; and processing the frame or packet to determine information contained in the frame or packet. Note that the communication between radio 132-2 and electronic device 116 or access point 130 may be characterized by a variety of performance metrics, such as: a data rate, a data rate for successful communication (which is sometimes referred to as a ‘throughput’), an error rate (such as a retry or resend rate), a mean-square error of equalized signals relative to an equalization target, intersymbol interference, multipath interference, an SNR, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 132 are shown in FIG. 1, one or more of these instances may be different from the other instances of radios 132.

As noted previously, it is often difficult to scale a food delivery service. Notably, many existing food delivery services are complicated and expensive, and suffer from food-preparation and delivery bottlenecks. All of which can degrade the overall customer experience.

In order to address these challenges, system 100 may be used to implement embodiments of the delivery technique in order to fulfill prepared-beverage orders. Notably, fulfillment hub 110 may store inventory for a set of prepared beverage products (such as coffee, teas, juice, a fresh fruit drink prepared from fruit, a fruit drink prepared from concentrate or pre-prepared contents, a perishable drink, etc.), and may provide to mobile stores 112 portions of the inventory from fulfillment hub 110 when mobile stores 112 return to a location of fulfillment hub 110 for resupply. Alternatively, or additionally, in some embodiments the one or more optional mobile hubs 114 may be used as intermediaries to provide portions of the inventory from fulfillment hub 110 to mobile stores 112 when mobile stores is at a locations of the one or more optional mobile hubs 114 (such as resupply location 124).

Note that fulfillment hub 110 and/or the one or more optional mobile hubs 114 may fabricate one or more pre-prepared portions of one or more prepared beverage products in the set of prepared beverage products. A pre-pre-prepared portion of a prepared beverage product may include a liquid corresponding to the prepared beverage product. For example, a prepared beverage product may include a type of tea, and a pre-prepared portion of the prepared beverage product may be a pre-steeped liquid and may have a tea-extract concentration that exceeds a tea-extract concentration of the final prepared beverage product. Alternatively, or additionally, the prepared beverage product may include a type of coffee, and the pre-prepared portion of the prepared beverage product may be a pre-brewed liquid and may have a coffee-extract concentration that exceeds a coffee-extract concentration of the final prepared beverage product. In some embodiments, the pre-prepared portion of the prepared beverage product includes pre-cooked tapioca pearls or a chemical that reduces perceived bitterness (such as sugar, milk, almond milk, soy milk or cream).

Subsequently, a customer may use one of electronic devices 118 (such as electronic device 118-1) to provide an order for one or more prepared beverage products to system 100. For example, during the ordering process, the customer may provide order information (such as a delivery location, e.g., delivery location 122, a delivery time or time interval, payment information, information that specifies the one or more prepared beverage products, etc.) that specifies the order by interacting with a Web page provided, via network 120, by electronic device 116. Alternatively, during the ordering process, the customer may use an application or app that is pre-installed on electronic device 118-1 to provide the order information. In some embodiments, the application or system 100 may provide a recommendation or a suggestion to the customer during the ordering process, such as a suggestion about a beverage or a product based at least in part on: the customer's: previous order history, an estimated delivery time (e.g., customers may prefer black tea immediately after lunch, but may prefer green tea in mid or late afternoon), and/or geographic location (e.g., Matcha tea may be popular around northern San Francisco, but black tea may be more popular around Burbank).

Then, electronic device 116 may receive the order information. In response, electronic device 116 may provide an instruction to at least one of mobile stores 112 (such as mobile store 112-1) to fulfill at least a subset of the order from the customer at the delivery location. For example, at least the subset of the order may include at least one prepared beverage product. Note that the instruction may include information specifying at least the subset of the order (such as the prepared beverage product), the delivery location, the delivery time or time interval, customization information (such as a topping for the prepared beverage product, an ingredient to avoid using in the prepared beverage product, e.g., milk or cream if the customer is lactose intolerant, customized artwork or a message to include on a delivery container, which is sometimes referred to as a ‘container,’ that will convey the prepared beverage product when it is delivered to the customer, etc.). In some embodiments, the customization information is selected or determined (such as using a neural network or a predictive model trained using a machine-learning technique) based at least in part on information associated with one or more previous orders for the prepared beverage product and/or another prepared beverage product by the customer, which were previously received by system 100.

In response to receiving the instruction, mobile store 112-1 may fabricate and deliver at least a subset of one or more prepared beverage products specified in at least the subset of the order to the delivery location. When fabricating the prepared beverage product, mobile store 112-1 may fabricate a remainder of the prepared beverage product using the pre-prepared portion of the prepared beverage product. For example, a beverage preparation device (such as a tea or coffee machine, an espresso machine, barista equipment, etc.) in mobile store 112-1 may fabricate the prepared beverage product by adding an amount of liquid (which may have a temperature that is higher than room temperature) to the pre-prepared portion of the prepared beverage product in order to obtain a desired concentration of the prepared beverage product and/or adding a topping to the prepared beverage product. For example, the amount of liquid may be: water, milk, another non-milk alternative (such as almond milk), another liquid, etc. Alternatively, or additionally, a printing device in mobile store 112-1 may fabricate the prepared beverage product by adding or printing the customized art work to a container (such as a cup, an empty container, or a container with at least partial pre-printed art work), and then the beverage preparation device may include or pour the prepared beverage product into the customized container.

Note that the use of the pre-prepared portion of the prepared beverage product may improve the efficiency of fabrication of the prepared beverage product, e.g., by reducing a fabrication time, which may reduce the cost of fabricating the prepared beverage product and may decrease a time between the order information being received and the delivery of the prepared beverage product. Moreover, the improved efficiency may allow mobile stores 112 to service or fulfill more customers per hour (by reducing, e.g., the workload of mobile stores 112 when fulfilling a particular order), which may reduce the amortized costs per delivery and may increase the profitability of the prepared-beverage delivery service. Furthermore, the ability to customize the container may personalize the customer experience. Individually or in combination with each other, these capabilities provided by the delivery technique may enhance the customer experience and may increase customer loyalty.

In some embodiments, electronic device 116 may predict the order by the customer (such as using a neural network or a predictive model trained using a machine-learning technique) based at least in part on information associated with one or more previous orders received by system 100, which may include a previous order by the customer for the prepared beverage product. Alternatively, or additionally, the order may be predicted based at least in part on a weather condition (such as the temperature or precipitation) or the current contents in a customer's order cart on a web page associated with electronic device 116. Based at least in part on this prediction, fulfillment hub 110 may provide the pre-prepared portion of the prepared beverage product or material that can be used to fabricate the prepared beverage product in the portion of the inventory to mobile store 112-1. Thus, fulfillment hub 110 may include supplies used to fabricate the prepared beverage product intended for the customer prior to electronic device 116 receiving the order from electronic device 118-1 (and, thus, prior to receiving the order from the customer).

Moreover, fulfillment hub 110 may provide at least a second portion of the inventory to another mobile store (such as mobile store 112-2). In response to receiving the order from electronic device 118-1 (and, thus, from the customer), electronic device 116 may split the order into the subset of the order fulfilled by mobile store 112-1 and a second subset of the order fulfilled by mobile store 112-2. Then, in addition to providing the instruction to mobile store 112-1, electronic device 116 may provide second instructions to fulfill the second subset of the order to mobile store 112-2. In response to receiving the second instructions, mobile store 112-2 may fabricate and deliver at least a second subset of one or more prepared beverage products in the second subset of the order to the delivery location.

The splitting of the order may be based at least in part on one or more of: a current or a projected (e.g., in 5, 10, 15, 30 or 60 min.) location of mobile store 112-1, a current or a projected (e.g., in 5, 10, 15, 30 or 60 min.) location of mobile store 112-2, an unused remainder of the portion of the inventory, an unused remainder of the second portion of the inventory, a current or a projected workload of mobile store 112-1 and/or a current or a projected workload of mobile store 112-2. In some embodiments, the splitting of the order may be based at least in part on how rapidly a particular mobile store (such as mobile store 112-1) fulfills previous orders relative to other mobile stores. For example, mobile stores 112 may provide information to electronic device 116 about the order fulfillment speed of staff in mobile stores 112 and/or cup-sealing devices or machines in mobile stores 112. Notably, the splitting may ensure that mobile stores 112-1 and 112-2 are capable of fulfilling the order in a timely manner. Thus, if there are multiple instances of a particular prepared beverage product in the order, these may be assigned to one of mobile stores 112-1 and 112-2 to simplify the fulfillment. Alternatively, or additionally, in order to ensure timely fulfillment, the splitting may be based at least in part on locations of mobile stores 112-1 and 112-2 and/or available inventory in mobile stores 112-1 and 112-2, so that the delivery time is timely (such as within a time interval) and/or the necessary inventory is available in a given mobile store to fulfill the order. Similarly, in some embodiments, the order may be split based at least in part on workloads of either or both of mobile stores 112-1 and 112-2, so that a particular mobile store is not overload with work, while another nearby mobile store is under-utilized .Furthermore, electronic device 116 may instruct one or more of mobile stores 112 to selectively share or exchange inventory to assist in fulfilling orders. This approach may allow mobile stores 112 to support each other, and to reduce or eliminate a near-term need (such as while fulfilling the order) for mobile stores 112 to be resupplied by the fulfillment hub 110 and/or the one or more optional mobile hubs 114. For example, a given mobile store (such as mobile store 112-1) may receive from another proximate (e.g., in an adjacent assigned geographic operating area or region) mobile store (such as mobile store 112-2) material in the second portion of the inventory. Alternatively, or additionally, mobile store 112-1 may provide to mobile store 112-2 material in the portion of the inventory. Notably, the material may be provided or received based at least in part on one or more of: an unused remainder of the portion of the inventory in mobile store 112-1, an unused remainder of the second portion of the inventory in mobile store 112-2, the order (such as the one or more prepared beverage products that are ordered), a location of mobile store 112-1, a location of mobile store 112-2, an assigned geographic operating region of mobile store 112-1, an assigned geographic operating region of mobile store 112-2, and/or a predicted future order based at least in part on information associated with the previous orders received by system 100. Thus, electronic device 116 may instruct mobile stores 112-1 and 112-2 to share or exchange the material or supplies when there is a need in, e.g., mobile store 112-1 (such as based at least in part on an assigned subset of current order), when there is available unused material in mobile store 112-2, and when mobile stores 112-1 and 112-2 are proximate to each other (such as when they are assigned to adjacent operating regions or based at least in part on their current locations, e.g., when a travel time between mobile stores 112-1 and 112-2 is less than a travel time to fabrication hub 110 and/or one of optional mobile hubs 114). In some embodiments, electronic device 116 may instruct mobile stores 112-1 and 112-2 to share or exchange the material or supplies based at least in part on forecast or predicted future demand (such as a predicted future order).

These capabilities may allow system 100 to flexibly adapt the fulfillment process and/or to dynamically shift, as needed, inventory among mobile stores 112 based at least in part on available resources to provide a superior customer experience (such as prompt delivery of ordered prepared beverage products).

In some embodiments, the hierarchical arrangement of fulfillment hub 110, the one or more optional mobile hubs 114 and mobile stores 112 may be dynamically adapted to address changes in customer demand, such as over the course of a day or at different times of a week or a year. For example, the portion of the inventory provided by fulfillment hub 110 may include different types of beverage products at different times of day. Alternatively, or additionally, electronic device 116 may vary the assigned regions of mobile stores 112 at different times of day. Note that these decisions may be based at least in part on information associated with the previous orders received by system 100 (e.g., using a neural network or a predictive model trained using a machine-learning technique). In some embodiments, the decisions may be dynamically adapted based at least in part on current orders received by system 100 (e.g., using a machine-learning technique to dynamically update a predictive model).

For example, in the morning, mobile stores 112 may fulfill customer orders from individuals, and the assigned geographic operating regions may be in residential areas. Then, in the afternoon, mobile stores 112 may fulfill customer orders from companies, and the assigned geographic operating regions may be in commercial areas. Similarly, depending on the type of customer (consumer vs. corporate) and/or the time of year, the types of prepared beverage products offered via mobile stores 112 may be changed. In some embodiments, the number of mobile stores 112 in operation may vary as a function of the time of day. Thus, there may be more mobile stores 112 that provide product A in operation in the morning and there may be more mobile stores 112 that provide product B in operation in the afternoon.

These capabilities may allow system 100 to dynamically adapt to changes in demand, in terms of location and the types of prepared beverage products, as a function of time. This may allow system 100 to flexibly use resources (such as the inventory at fulfillment hub 110, mobile stores 112 and the one or more optional mobile hubs 114) to increase revenue and to meet customer needs.

In these ways, the delivery technique may provide a scalable, cost-effective and profitable prepared-beverage delivery service, which offers high-quality products and a superior overall customer experience.

While the preceding discussion illustrated the delivery technique with prepared beverage products, in other embodiments system 100 may be used to provide prepared foods (such as a macaroon), packaged goods or other products (such as novelty items), either separately or in conjunction with the prepared beverage products. Alternatively, or additionally, in some embodiments the delivery technique is used to provide products that customers need quickly or in a short time interval (such as within 30 min), such as pain killers (e.g., aspirin, Tylenol, naproxen, etc.) or condoms.

Furthermore, in some embodiments some or all of the operations performed by one or more components in system 100 (such as by fulfillment hub 110 or mobile stores 112) are highly or completely automated. For example, mobile stores 112 may fabricate the prepared beverage products with limited human assistance or without human assistance using automated beverage preparation devices. These beverage preparation devices may automatically load individual cartridges with the pre-prepared portions of the prepared beverage products and may automatically add other ingredients (e.g., milk, cream, almond milk, soy milk, etc.) to fabricate the prepared beverage products. Alternatively, or additionally, the beverage preparation devices may automatically transfer predefined amounts of pre-prepared portions of the prepared beverage products from storage containers and may automatically add other ingredients to fabricate the prepared beverage products. In some embodiments, mobile stores 112 may have partial or full autonomous driving or self-driving capability, which may allow mobile stores 112 to drive to the location of fulfillment hub 110, the one or more optional mobile hubs 114 and/or the delivery locations. Additionally, at the delivery locations, robots or smaller autonomous vehicles or drones may be used to bring the prepared beverage products to the customers.

However, in some embodiments, at least a portion of the fulfillment process or operations in the delivery technique are performed by or at least partially implemented by humans, such as employees of or contractors associated with a prepared-beverage delivery service that is offered by an operator of system 100. For example, one or more electronic devices in system 100 (such as electronic device 116) may execute software that determines portions of the inventory that are loaded onto mobile stores 112 and/or current assigned geographic operating regions for mobile stores 112 at different times, e.g., on different days of the week and/or at different times of the year. This inventory information may be provided to staff at fulfillment hub 110 and/or in mobile stores 112 (e.g., it may be displayed on a display or printed out), who then provide the portions of the inventory to mobile stores 112. In addition, the assigned geographic operating regions may be provided to mobile stores 112 and it may be presented to drivers or staff of these mobile stores, e.g., it may be displayed on displays (such as by mapping software or application executed on electronic devices in mobile stores 112).

Subsequently, drivers my drive mobile stores 112 within the assigned geographic operating regions. Moreover, when an order is received, an electronic device in system 100 (such as electronic device 116) may communicate associated instructions to one or more of mobile stores 112. The instructions may be presented to drivers and/or baristas in one or more mobile stores 112 (e.g., the instructions may be presented on a display), who may use beverage preparation devices in mobile stores 112 to fabricate the prepared beverage products. Furthermore, the drivers in one or more mobile stores 112 may drive the one or more mobile stores 112 to one or more the delivery locations and may exit the mobile stores when delivering the prepared beverage products.

In some embodiments, any manual operations in the delivery technique may be increasingly or fully automated over time, as necessary technology becomes available or cost effective for this application.

Although we describe system 100 as an example, in alternative embodiments, different numbers or types of electronic devices or components may be present. For example, some embodiments comprise more or fewer electronic devices or components. Therefore, in some embodiments there may be fewer or additional instances of at least some of the electronic devices or components. As another example, in another embodiment, different electronic devices may be transmitting and/or receiving frames or packets.

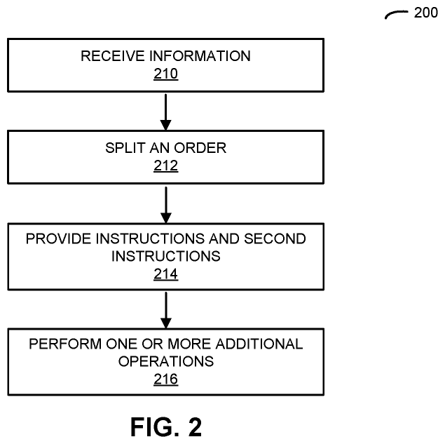

We now describe embodiments of the method. FIG. 2 presents a flow diagram illustrating an example of a method 200 for fulfilling prepared-beverage orders in a system. This method may be performed by an electronic device in a system, such as electronic device 116 in system 100 in FIG. 1.

During operation, the electronic device may receive information (operation 210) specifying an order, where the order is associated with a customer and includes information specifying a destination location and multiple prepared beverage products.

Then, the electronic device may split the order (operation 212) into a subset of the order fulfilled by a mobile store in the system and a second subset of the order fulfilled by a second mobile store in the system, where fulfilling a given subset of the order involves use of a given mobile store to fabricate one or more prepared beverage products in a set of prepared beverage products using a given portion of inventory from a fabrication hub in the system and to deliver the one or more prepared beverage products to a given destination location. Note that the splitting may be based at least in part on one or more of: a location of the mobile store, a location of the second mobile store, an unused remainder of a portion of the inventory in the mobile store, an unused remainder of a second portion of the inventory in the second mobile store, a workload of the mobile store, and/or a workload of the second mobile store.

Next, the electronic device may provide an instruction intended for the mobile store and a second instruction intended for the second mobile store (operation 214), where the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.

In some embodiments, the system optionally performs one or more additional operations (operation 216). For example, the electronic device may provide information, intended for the fabrication hub or the set of mobile stores, that specifies portions of the inventory for the set of mobiles stores, where the portions of the inventory are varied at different times of day based at least in part on previous orders received by the system. Furthermore, the electronic device may predict the order based at least in part on a previous order from the customer for an instance or a prepared beverage product, which was received by the system. Additionally, prior to the electronic device receiving the order (operation 210), the electronic device may provide information, intended for the fabrication hub or the mobile store, that specifies the portion of the inventory for the mobile store that includes ingredients in the prepared beverage product based at least in part on the prediction.

In some embodiments, the instruction and/or the second instruction may specify exchange of material in the portion of the inventory or the second portion of the inventory between the mobile store and the second mobile store. Note that the exchanged material may be based at least in part on: an unused remainder of the portion of the inventory in the mobile store, an unused remainder of the second portion of the inventory in the second mobile store, the subset of the order, the second subset of the order, a location of the mobile store, a location of the second mobile store, an assigned geographic operating region of the mobile store, an assigned geographic operating region of the second mobile store, and/or a predicted future order based at least in part on the previous orders received by the system. Note that the assigned geographic operating regions may be orthogonal, at least partially overlapping or the same (such as a particular city or a region or neighborhood in a city).

Moreover, the electronic device may provide information, intended for the set of mobile stores, that specifies the assigned geographic operating regions, where the assigned geographic operating regions are varied at different times of day based at least in part on previous orders received by the system.

In some embodiments, the information specifying the order includes a time or timestamp, and the instructions and/or the second instructions include a delivery time. For example, the delivery time may be within 30 minutes of the time or the timestamp.

In some embodiments of method 200, there may be additional or fewer operations. Moreover, the order of the operations may be changed, and/or two or more operations may be combined into a single operation.

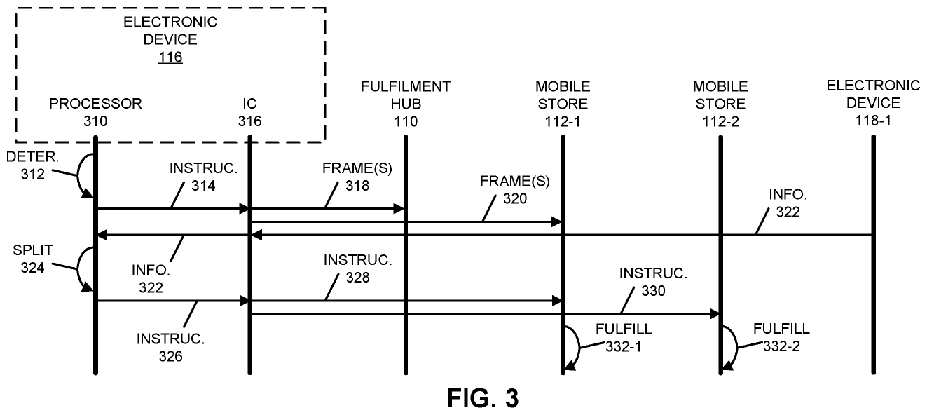

FIG. 3 presents a drawing illustrating an example of interactions among fulfilment hub 110, mobile store 112-1, mobile store 112-2, electronic device 116 and electronic device 118-1. In FIG. 3, a processor 310 in electronic device 116, which executes software or program instructions, may determine 312 portions of inventory for mobile hubs 112-1 and 112-2 and/or assigned geographic operating regions for mobile hubs 112-1 and 112-2. Then, processor 310 may instruct 314 interface circuit (IC) 316 in electronic device to communicate one or more packets or frames 318 with information that specifies the portions to fulfilment hub 110 and to communicate one or more packets or frames 320 with information that specifies the portions and/or the assigned geographic operating regions to mobile stores 112-1 and 112-2.

In response to frames 318, fabrication hub 110 (or staff at fabrication hub 110, such as an employee or a contractor who has an employment or a business relationship with a provider of a prepared-beverage delivery service) may provide the portions of inventory to mobile stores 112-1 and 112-2. For example, the portions of the inventory may be loaded onto mobile stores 112-1 and 112-2.

Subsequently, a customer may use electronic device 118-1 to provide information 322 that specifies an order.

After receiving information 322, an interface circuit 316 may provide information 322 to a processor 310. In response, processor 310 may determine to split 324 the order, such that a subset of the order fulfilled by mobile store 112-1 and a second subset of the order fulfilled by mobile store 112-2. Note that fulfilling a given subset of the order may involve use of a given mobile store to fabricate one or more prepared beverage products in a set of prepared beverage products using a given portion of inventory from fabrication hub 110 and to deliver the one or more prepared beverage products to a given destination location.

Next, processor 310 may provide instructions 326 specifying how mobile stores 112-1 and 112-2 are to fulfill the subsets of the order to interface circuit 316. In response, interface circuit 316 may provide instructions 328 to mobile store 112-1 (e.g., using one or more packets or frames) and instructions 330 to mobile store 112-2 (e.g., using one or more packets or frames).

After receiving instructions 326 and 330, respectively, mobile stores 112-1 and 112-2 may (or may be used to, e.g., by staff associated with mobile stores 112-1 and 112-2) fulfill 332 the respective subsets of the order. Notably, mobile stores 112-1 and 112-2 may be used to fabricate the subsets and to deliver prepared beverage products to a destination location associated with the order. Alternatively, instructions 330 to mobile store 112-2 may specify an exchange location. After the second subset of the order has been prepared or fabricated by mobile store 112-2 (or staff in mobile store 112-2), the second subset of the order may be provided to mobile store 112-1 at the exchange location (e.g., by staff associated with mobile stores 112-1 and 112-2). Then, mobile store 112-1 may be used to deliver the prepared beverage products to the destination location associated with the order.

Note that, in some embodiments, information 322 specifying the order includes a time or timestamp, and instructions 326 and/or instructions 330 include a delivery time. For example, the delivery time may be within 30 minutes of the time or the timestamp.

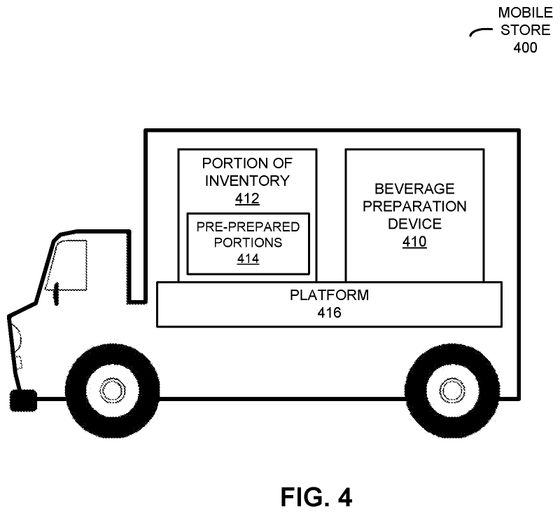

FIG. 4 presents a drawing illustrating an example of a mobile store 400 (such as one of mobile stores 112 in FIG. 1). This mobile store may include (inside of mobile store 400) a beverage preparation device (BPD) 410 and a portion of inventory 412 from fulfillment center 110 (FIG. 1) or one of optional mobile hubs 114 (FIG. 1). Moreover, the portion of inventory 412 may include pre-prepared portions 414 of one or more prepared beverage products.

In some embodiments, the beverage preparation device 410 and the portion of inventory 412 may be included on (e.g., attached to or mounted on) a portable pallet or platform 416 that can be easily loaded onto or removed from mobile store 400. In this way, the necessary contents in mobile store 400 that are used to fulfill an order can be rapidly swapped out of mobile store 400. This may allow fast provisioning or turn around of mobile store 400 at fulfillment center 110 (FIG. 1) or one of optional mobile hubs 114 (FIG. 1). Thus, platform 416 may be pre-load for use by mobile store 400. Then, when mobile store 400 is being serviced, platform 416 may quickly be loaded onto mobile store 400 to replace an existing platform on mobile store 400. This approach may allow mobile store 400 to be rapidly re-supplied or re-configured (such as with a different portion of the inventory for use in a new assigned geographic operating region). Note that the use of platform 416 may also allow the beverage preparation device 410 to be easily serviced or cleaned at fulfillment center 110 (FIG. 1) or one of optional mobile hubs 114 (FIG. 1).

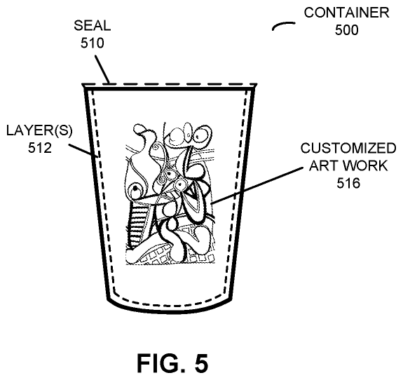

FIG. 5 presents a drawing illustrating an example of a container 500 for a prepared beverage. This container may have a removable seal 510 over a top opening of container 500 to securely protect a prepared beverage product conveyed in container 500 until it is opened or removed by a customer. When seal 510 is removed or opened, there may be a visual clue, so the customer can see if container 500 has been tampered with before they attempted to open container 500.

Moreover, container 500 may include one or more layers 512 that provides environmental protection for the prepared beverage product conveyed in container 500. For example, the one or more layers 512 may provide thermal insulation (so that heat does not diffuse in or out of container 500) and/or a diffusion barrier for moisture or an oxidizer (such as oxygen). For example, the one or more layers 512 may include thermal insulation and a metal layer. In this way, container 500 may protect or ensure the quality of the prepared beverage product and, thus, may be suitable for use in a variety of environments having different temperatures (which are higher or lower than that of the prepared beverage product), different relative humidity, etc.

In some embodiments, an outer surface of container 500 may be used to present customized art work 514 or messages to a customer. For example, the customized art work 514 may be one of a set of predefined or standard patterns or designs. A suitable design may be selected based at least in part on customer attributes, customer preferences, customer demographic information, a customer profile (such as a customer birthday), information associated with one or more previous orders received from the customer (such as preferences of customers in a similar geographic areas), holiday information, a birthday and/or a selection provided by the customer. Note that the customized art work 514 may be rapidly disposed on (e.g., sprayed onto or defined on) container 500 by a device in a mobile store, such as a beverage preparation device. In some embodiments, the customized art work 514 is made of a wax having a melting temperature exceeding that of the prepared beverage product conveyed in container 500. Alternatively, or additionally, the customized art work 514 may be made of ink.

In some embodiments of the delivery technique, an electronic device in a system splits an order between two or more mobile stores. For example, if an order has a delivery location in an assigned geographic operating region of a mobile store, but a number of prepared beverage products in the order exceeds a preparation capacity of the mobile store (or the barista in the mobile store) in an allotted time interval until the order needs to be delivered (such as, e.g., 20 prepared beverage products in 15 min), the order may be split, with a percentage of the order being assigned to a second mobile store that is nearby (such as in an adjacent assigned geographic operating region, e.g., a proximate neighborhood or street). If the second mobile store currently is not fulfilling another order, the percentage may be 50% (such as 10 of the 20 prepared beverage products in the order). However, if the second mobile store is fulfilling another order, the percentage may be selected so that the subset of the order assigned to the second mobile store does not exceeds a preparation capacity (e.g., 20 prepared beverage products in 15 min.) of the second mobile store (or the barista in the second mobile store). Thus, the splitting percentages or the subsets assigned to the mobile store and/or the second mobile store may be based at least in part on the current workloads of the mobile store and/or the second mobile store relative to their preparation capacities.

Note that available inventory may be a constraint on the splitting of the order. For example, if the second mobile store does not currently have the necessary ingredients to fulfill a particular prepared beverage product in the order, then the electronic device may not assign this particular prepared beverage product to the second mobile store.

Alternatively, in some embodiments, if the second mobile store does not currently have the necessary ingredients to fulfill a particular prepared beverage product, the electronic device may instruct a third mobile store that has the necessary ingredients and that is proximate to the second mobile store, but which is too far away to timely assist the mobile store in fulfilling the order (and, thus, will not participate in the splitting of the order), to provide the necessary ingredients to the second mobile store. For example, the third mobile store may be instructed to meet the second mobile store at a particular location and time, and then to transfer the necessary ingredients to the second mobile store. Based on this transfer, the electronic device may split the order and may include the particular prepared beverage product in the subset fulfilled by the second mobile store. In some embodiments, the transfer or exchange of inventory between two or more of the mobile stores may be based at least in part on a predicted future order (such as based at least in part on one or more previous orders for one or more prepared beverage products having associated destination addresses and delivery days/times), as opposed to a pending current order.

Moreover, the portions of the inventory in the mobile stores may be varied as a function of time. For example, in the morning, a mobile store may have an assigned geographic operating region in a residential area, and the portion of the inventory in the mobile store may include ingredients for types of coffee and tea, as well as prepared breakfast foods. Then, in the afternoon, a mobile store may have an assigned geographic operating region in a commercial area, and the portion of the inventory in the mobile store may include ingredients for different types of coffee and tea, as well as prepared snacks or lunch foods. In some embodiments, the portion of the inventory in the mobile store may vary on different days of the week (such as work days versus a weekend) and/or at different times of the year (such as around particular holidays).

Furthermore, when the electronic device predicts a prepared beverage product in a future order (such as based at least in part on past or previous orders for prepared beverage product from a particular customer having a particular delivery address), ingredients or material used to fabricate the particular prepared beverage product may be included in the portion of the inventory in the mobile store that has an assigned geographic operating region that includes the delivery address on the day and/or around the time of the predicted order. This anticipation may allow the mobile store (or a barista in the mobile store) to be able to fulfill an eventual order for this prepared beverage product.

Additionally, as noted previously, the electronic device may vary the assigned geographic operating region of a mobile store as a function of time of day (such as a residential area in the morning and a commercial area in the afternoon), day of the week (a commercial area on weekdays and a residential area on weekends), and/or a time of year (such as near a park or outdoor venue in the Spring, Summer and Fall). These assignments may be based at least in part on one or more previous orders received by the system.

In some embodiments, an electronic device in the system may dynamically idle one or more mobile stores based at least in part on current demand or orders that are being received. For example, a mobile store may be taken out of operation or temporarily packed at a nearby location. This may allow the operating cost associated with the mobile store to be dynamically reduced when there are insufficient orders for prepared beverages being received to justify operation of the mobile store.

In some embodiments, prepared beverage product is a type of tea. To facilitate fabrication of the prepared beverage product, a pre-prepared portion of the prepared beverage product may be used. For example, a pre-prepared portion may be a type of tea that is pre-steeped. The resulting pre-prepared portion of the prepared beverage product may be a concentrated tea extract without the tea leaf. The concentration in the pre-prepared portion of the prepared beverage product may be higher than the prepared beverage product. Note that the temperature and the steeping time used when fabricating the pre-prepared portion of the prepared beverage product may depend on the type of tea. For black tea, the temperature may be 210 F and a steeping time of 10 min. For green tea, the temperature may be 170-185 F and a steeping time of 8 min. For other types of tea, the steeping time may be 30 min. (such as for Matcha tea) or overnight (such as 12 hrs. for chai tea).

We now describe embodiments of an electronic device, which may perform at least some of the operations in the delivery technique. For example, the electronic device may include a component in system 100 (such as electronic device 116) or one of electronic devices 118. FIG. 6 presents a block diagram illustrating an electronic device 600 in accordance with some embodiments. This electronic device includes processing subsystem 610, memory subsystem 612, and networking subsystem 614. Processing subsystem 610 includes one or more devices configured to perform computational operations. For example, processing subsystem 610 can include one or more microprocessors, ASICs, microcontrollers, programmable-logic devices, graphical processor units (GPUs) and/or one or more digital signal processors (DSPs).

Memory subsystem 612 includes one or more devices for storing data and/or instructions for processing subsystem 610 and networking subsystem 614. For example, memory subsystem 612 can include dynamic random access memory (DRAM), static random access memory (SRAM), and/or other types of memory (which collectively or individually are sometimes referred to as a ‘computer-readable storage medium’). In some embodiments, instructions for processing subsystem 610 in memory subsystem 612 include: program instructions or sets of instructions (such as program instructions 622 or operating system 624), which may be executed by processing subsystem 610. Note that the one or more computer programs may constitute a computer-program mechanism. Moreover, instructions in the various modules in memory subsystem 612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 610.

In addition, memory subsystem 612 can include mechanisms for controlling access to the memory. In some embodiments, memory subsystem 612 includes a memory hierarchy that comprises one or more caches coupled to a memory in electronic device 600. In some of these embodiments, one or more of the caches is located in processing subsystem 610.

In some embodiments, memory subsystem 612 is coupled to one or more high-capacity mass-storage devices (not shown). For example, memory subsystem 612 can be coupled to a magnetic or optical drive, a solid-state drive, or another type of mass-storage device. In these embodiments, memory subsystem 612 can be used by electronic device 600 as fast-access storage for often-used data, while the mass-storage device is used to store less frequently used data.

Networking subsystem 614 includes one or more devices configured to couple to and communicate on a wired and/or wireless network (i.e., to perform network operations), including: control logic 616, an interface circuit 618 and one or more antennas 620 (or antenna elements). (While FIG. 6 includes one or more antennas 620, in some embodiments electronic device 600 includes one or more nodes, such as nodes 608, e.g., a pad, which can be coupled to the one or more antennas 620. Thus, electronic device 600 may or may not include the one or more antennas 620.) For example, networking subsystem 614 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, a LoRa communication protocol, and/or another networking system.

Networking subsystem 614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 600 may use the mechanisms in networking subsystem 614 for performing simple wireless communication between the electronic devices, e.g., transmitting frames and/or scanning for frames transmitted by other electronic devices.

Within electronic device 600, processing subsystem 610, memory subsystem 612, and networking subsystem 614 are coupled together using bus 628. Bus 628 may include an electrical, optical, and/or electro-optical connection that the subsystems can use to communicate commands and data among one another. Although only one bus 628 is shown for clarity, different embodiments can include a different number or configuration of electrical, optical, and/or electro-optical connections among the subsystems.

In some embodiments, electronic device 600 includes a display subsystem 626 for displaying information on a display, which may include a display driver and the display, such as a liquid-crystal display, a multi-touch touchscreen, etc.

Electronic device 600 can be (or can be included in) any electronic device with at least one network interface. For example, electronic device 600 can be (or can be included in): a desktop computer, a laptop computer, a subnotebook/netbook, a server, a computer, a mainframe computer, a cloud-based computer, a tablet computer, a smartphone, a cellular telephone, a smartwatch, a consumer-electronic device, a portable computing device, an access point, a transceiver, a controller, a radio node, a router, a switch, communication equipment, a wireless dongle, an access point, test equipment, and/or another electronic device.

Although specific components are used to describe electronic device 600, in alternative embodiments, different components and/or subsystems may be present in electronic device 600. For example, electronic device 600 may include one or more additional processing subsystems, memory subsystems, networking subsystems, and/or display subsystems. Additionally, one or more of the subsystems may not be present in electronic device 600. Moreover, in some embodiments, electronic device 600 may include one or more additional subsystems that are not shown in FIG. 6. Also, although separate subsystems are shown in FIG. 6, in some embodiments some or all of a given subsystem or component can be integrated into one or more of the other subsystems or component(s) in electronic device 600. For example, in some embodiments program instructions 622 are included in operating system 624 and/or control logic 616 is included in interface circuit 618.

Moreover, the circuits and components in electronic device 600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘means for computation’) may implement some or all of the functionality of networking subsystem 614 or electronic device 600. The integrated circuit may include hardware and/or software mechanisms that are used for transmitting wireless signals from electronic device 600 and receiving signals at electronic device 600 from other electronic devices. Aside from the mechanisms herein described, radios are generally known in the art and hence are not described in detail. In general, networking subsystem 614 and/or the integrated circuit can include any number of radios. Note that the radios in multiple-radio embodiments function in a similar way to the described single-radio embodiments.

In some embodiments, networking subsystem 614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the delivery technique may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the delivery technique may be implemented using program instructions 622, operating system 624 (such as a driver for interface circuit 618) or in firmware in interface circuit 618. Alternatively, or additionally, at least some of the operations in the delivery technique may be implemented in a physical layer, such as hardware in interface circuit 618.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the delivery technique, different numerical values may be used.

The foregoing description is intended to enable any person skilled in the art to make and use the disclosure and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A system, comprising:
a fulfillment hub configured to store inventory for a set of prepared beverage products;
a set of mobile stores configured to:
receive portions of the inventory from the fulfillment hub;
move to different locations in assigned geographic operating regions; and
fulfill orders, wherein the fulfilling involves use of the set of mobile stores to fabricate prepared beverage products in the set of prepared beverage products using the portions of the inventory and to deliver the prepared beverage products to destination locations; and
an electronic device configured to:
receive information specifying an order, wherein the order is associated with a customer and comprises information specifying a destination location, a desired delivery time, and multiple prepared beverage products;
split the order into a subset of the order fulfilled by a mobile store in the set of mobile stores and a second subset of the order fulfilled by a second mobile store in the set of mobile stores, wherein the splitting is based at least in part on one or more of: a location of the mobile store, a location of the second mobile store, an unused remainder of a portion of the inventory in the mobile store, an unused remainder of a second portion of the inventory in the second mobile store, a workload of the mobile store, or a workload of the second mobile store; and
provide an instruction intended for the mobile store and a second instruction intended for the second mobile store, wherein the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.

2. The system of claim 1, wherein the set of prepared beverage products comprise coffees and teas.

3. The system of claim 1, wherein the electronic device is configured to provide information, intended for the fabrication hub or the set of mobile stores, that specifies the portions of the inventory for the set of mobiles stores; and
wherein the portions of the inventory are varied at different times of day based at least in part on previous orders received by the system.

4. The system of claim 3, wherein the electronic device is configured to predict the order based at least in part on a previous order from the customer for an instance or a prepared beverage product, which was received by the system; and
wherein, prior to the electronic device receiving the order, the electronic device provides information, intended for the fabrication hub or the mobile store, that specifies the portion of the inventory for the mobile store that comprises ingredients in the prepared beverage product based at least in part on the prediction.

5. The system of claim 3, wherein the instruction or the second instruction specifies exchange of material in the portion of the inventory or the second portion of the inventory between the mobile store and the second mobile store; and
wherein the exchanged material is based at least in part on one or more of: an unused remainder of the portion of the inventory in the mobile store, an unused remainder of the second portion of the inventory in the second mobile store, the subset of the order, the second subset of the order, a location of the mobile store, a location of the second mobile store, an assigned geographic operating region of the mobile store, an assigned geographic operating region of the second mobile store, or a predicted future order based at least in part on the previous orders received by the system.

6. The system of claim 1, wherein the electronic device is configured to provide information, intended for the set of mobile stores, that specifies the assigned geographic operating regions; and
wherein the assigned geographic operating regions are varied at different times of day based at least in part on previous orders received by the system.

7. The system of claim 1, wherein the portions of the inventory comprise pre-prepared portions of prepared beverage products in the set of prepared beverage products;
wherein a pre-prepared portion of a prepared beverage product comprises a liquid corresponding to the prepared beverage product; and
wherein the fulfilling involves use of the set of mobiles stores to fabricate remainders of the prepared beverage products using the pre-prepared portions of the prepared beverage products.

8. The system of claim 7, wherein the prepared beverage product comprises a type of tea and the pre-prepared portion of the prepared beverage product is a pre-steeped liquid and has a tea-extract concentration that exceeds a tea-extract concentration of the prepared beverage product.

9. The system of claim 7, wherein the prepared beverage product comprises a type of coffee and the pre-prepared portion of the prepared beverage product is a pre-brewed liquid and has a coffee-extract concentration that exceeds a coffee-extract concentration of the prepared beverage product.

10. The system of claim 7, wherein the pre-prepared portion of the prepared beverage product comprises pre-cooked tapioca pearls.

11. The system of claim 7, wherein fabricating the remainders of the prepared beverage products comprises adding amounts of liquid to the pre-prepared portions of the prepared beverage products to obtain desired concentrations of the prepared beverage products.

12. The system of claim 7, wherein fabricating the remainders of the prepared beverage products comprises adding customized art work to containers that convey the prepared beverage products.

13. The system of claim 12, wherein given customized art work is selected based at least in part on information about a given customer associated with previous orders received by the system.

14. A non-transitory computer-readable storage medium for use in conjunction with an electronic device in a system, the computer-readable storage medium storing program instructions that, when executed by the electronic device, causes the electronic device to perform one or more operations, comprising:
receiving information specifying an order, wherein the order is associated with a customer and comprises information specifying a destination location, a desired delivery time, and multiple prepared beverage products;
splitting the order into a subset of the order fulfilled by a mobile store in the system and a second subset of the order fulfilled by a second mobile store in the system, wherein fulfilling a given subset of the order involves use of a given mobile store to fabricate one or more prepared beverage products in a set of prepared beverage products using a given portion of inventory from a fabrication hub in the system and to deliver the one or more prepared beverage products to a given destination location, and wherein the splitting is based at least in part on one or more of: a location of the mobile store, a location of the second mobile store, an unused remainder of a portion of the inventory in the mobile store, an unused remainder of a second portion of the inventory in the second mobile store, a workload of the mobile store, or a workload of the second mobile store; and
providing an instruction intended for the mobile store and a second instruction intended for the second mobile store, wherein the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.

15. The non-transitory computer-readable storage medium of claim 14, wherein the set of prepared beverage products comprise coffees and teas.

16. The non-transitory computer-readable storage medium of claim 14, wherein the one or more operations comprise providing information, intended for the fabrication hub or the mobile store and the second mobile store, that specifies portions of the inventory for the mobile store and the second mobile store; and
wherein the portions of the inventory are varied at different times of day based at least in part on previous orders received by the system.

17. The non-transitory computer-readable storage medium of claim 16, wherein the instruction or the second instruction specifies exchange of material in the portion of the inventory or the second portion of the inventory between the mobile store and the second mobile store; and
wherein the exchanged material is based at least in part on one or more of: an unused remainder of the portion of the inventory in the mobile store, an unused remainder of the second portion of the inventory in the second mobile store, the subset of the order, the second subset of the order, a location of the mobile store, a location of the second mobile store, an assigned geographic operating region of the mobile store, an assigned geographic operating region of the second mobile store, or a predicted future order based at least in part on previous orders received by the system.

18. The non-transitory computer-readable storage medium of claim 14, wherein the one or more operations comprise providing information, intended for the mobile store and the second mobile store, that specifies assigned geographic operating regions of the mobile store and the second mobile store; and
wherein the assigned geographic operating regions are varied at different times of day based at least in part on previous orders received by the system.

19. The non-transitory computer-readable storage medium of claim 14, wherein portions of the inventory comprise pre-prepared portions of prepared beverage products in the set of prepared beverage products;
wherein a pre-prepared portion of a prepared beverage product comprises a liquid corresponding to the prepared beverage product; and
wherein the fulfilling involves use of the set of mobiles stores to fabricate remainders of the prepared beverage products using the pre-prepared portions of the prepared beverage products.

20. A method for fulfilling prepared-beverage orders, comprising:
by an electronic device in a system:
receiving information specifying an order, wherein the order is associated with a customer and comprises information specifying a destination location, a desired delivery time, and multiple prepared beverage products;
splitting the order into a subset of the order fulfilled by a mobile store in the system and a second subset of the order fulfilled by a second mobile store in the system, wherein fulfilling a given subset of the order involves use of a given mobile store to fabricate one or more prepared beverage products in a set of prepared beverage products using a given portion of inventory from a fabrication hub in the system and to deliver the one or more prepared beverage products to a given destination location, and wherein the splitting is based at least in part on one or more of: a location of the mobile store, a location of the second mobile store, an unused remainder of a portion of the inventory in the mobile store, an unused remainder of a second portion of the inventory in the second mobile store, a workload of the mobile store, or a workload of the second mobile store; and
providing an instruction intended for the mobile store and a second instruction intended for the second mobile store, wherein the instruction specifies the destination location and the subset of the order to be fulfilled by the mobile store, and the second instruction specifies the second subset of the order to be fulfilled by the second mobile store and one of: the destination location or an exchange location where the second subset of the order is to be provided to the mobile store.
